(19) United States
(12) Patent Application Publication
(10) Pub. No.: US 2004/0176968 A1
(43) Pub. Date: Sep. 9, 2004

(54) Systems and methods for dynamically configuring business processes

(75) Inventors: Raza M. Syed, Redmond, WA (US); Mikhail Mikhailov, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/384,449

(22) Filed: Mar. 7, 2003

(51) Int. Cl. G06F 17/60

(52) U.S. Cl. 705/1

(57) ABSTRACT

Systems and methods for dynamic business process configuration are provided that allow developers to introduce points of variances (parameters/policies) at well-defined places in business processes. The values of these parameters/policies are dependent on the context in which the business process is executed. This context can be defined and modified by business users after deployment based upon the changing needs of the business. The same business processes can be utilized in different contexts without recompilation and involvement of development resources. In one embodiment, to implement dynamic business process configuration, a set of web services APIs is provided that process developers can leverage to add points of variability in their processes. The API talks to a data-model for business processes and trading partners. Once the processes are built leveraging the API, they can be deployed through a set of tools. Also, business users can tailor the business process using an artifact called an agreement using other tools for different scenarios after deployment, as needed, without recompiling or rebuilding the process.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright©2002-2003, Microsoft Corp.

### FIELD OF THE INVENTION

The present invention is directed to systems and methods for dynamically configuring business processes in connection with run-time computing systems.

### BACKGROUND

Today, there is no dynamic business process configurable scheme available for business users. For instance, once a business process is placed into operation, the business process is hard to change and adapt to fulfill the dynamic needs of real world business. In addition, business processes are mostly developed from scratch, thus requiring a new development cycle for every new business situation. Such a development cycle may take between 60 and 180 days, for example, which is an unacceptable delay to virtually all fast moving businesses that need to stay at the leading edge of customer demands and requirements. Moreover, this may require re-compilation, and re-deployment, wherein, e.g., an end user may have to run a batch file, or follow another installation procedure, to replace old bits with the new bits that behave currently. By the time the new code is developed, re-compiled and re-deployed, the business needs for the business process may have changed again in the meantime, frustrating the original goal.

Thus, currently, business processes are created to solve unique business situations, but they lack the capability to be configured by business users after deployment. This generally means that every enterprise starts building a process from scratch and there is no efficient mechanism for ISVs or business partners to provide templatized business processes for vertical industries. For this reason, business process automation projects are limited to large enterprises, which can afford to bear the cost of building everything from scratch. Since large partners invariably deal with small to medium sized businesses that lack business process automation capabilities, implementing B2B processes and enablement of partnerships remains a complex and painful experience. Additionally, there is currently no way of achieving aggregate business activity monitoring (BAM). It would thus be desirable to be able to collect data about instances automatically in order to implement aggregate policies.

In short, the current state of the art of business process automation has the major limitation that it can not fulfill the dynamic needs of business. Thus, it would be desirable to enable dynamic business process configuration that allows developers to introduce points of variance, e.g., parameters or policies, at well-defined places in the business processes. It would be further desirable to make the values of these parameters or policies dependent on the context in which the business process is executed, such that the context could be defined and modified by business users after deployment based upon the ever evolving needs of the business. This would allow the same business process to be used in different contexts without recompilation and involvement of development resources. The enablement of end-user configuration of business processes is an extremely key feature that is lacking in run time systems today.

### SUMMARY OF THE INVENTION

The systems and methods for providing dynamic business process configuration of the invention allow developers to introduce points of variances (parameters/policies) at well-defined places in business processes. The values of these parameters/policies are dependent on the context in which the business process is executed. This context can be defined and modified by business users after deployment based upon the changing needs of the business. The invention allows the same business processes to be utilized in different contexts without recompilation and involvement of development resources. In one embodiment, to implement dynamic business process configuration in accordance with the invention, a web services API is provided that process developers can leverage to add points of variability in their processes. The API talks to a data-model for business processes and trading partners. Once the processes are built leveraging the API, they can be deployed through a set of tools provided by the invention. Also, business users can tailor the business process using an artifact called an agreement using other tools for different scenarios after deployment, as needed, without recompiling or rebuilding the process.

Other features and embodiments of the present invention are described below.

### BRIEF DESCRIPTION OF THE DRAWINGS

The systems and methods for dynamically configuring business processes in accordance with the present invention are further described with reference to the accompanying drawings in which:

FIG. 1 illustrates an exemplary process to which the dynamic business process configuration capabilities can be applied in accordance with the present invention;

FIG. 2A is a block diagram representing an exemplary network environment having a variety of computing devices in which the present invention may be implemented;

FIG. 2B is a block diagram representing an exemplary non-limiting computing device in which the present invention may be implemented;

FIG. 3 illustrates an exemplary diagram showing how policies can be checked in accordance with the dynamic business process configuration techniques of the invention;

FIG. 4 illustrates the operation of an exemplary runtime parameter retrieval process in accordance with the invention;

FIG. 5 shows architectural components of an exemplary arrangement of the Business Process Configuration Architecture in accordance with the invention;

FIG. 6 illustrates an exemplary agreement structure in accordance with the invention;

FIG. 7 illustrates an exemplary general architecture for the Agreement system of the invention;

FIG. 8 illustrates how agreements can be created and modified in accordance with an embodiment of the invention;

FIG. 9 illustrates exemplary operation of a policy monitor in accordance with the invention; and

FIGS. 10A through 10D illustrate an exemplary end to end process for utilizing the present invention from business process designer to run-time use of the dynamically configurable business process enabled by various embodiments of the invention.

### DETAILED DESCRIPTION OF THE INVENTION

Overview

Dynamic business process configuration is a practical means by which business processes can be made configurable so that the same overall process can be leveraged in a variety of scenarios, or under a variety of configurable parameters. Such configurable business processes can be developed by independent software vendors (ISVs) or internal developers to model the fixed patterns of interaction while exposing hooks to associate appropriate participants, i.e., organizational/system/user profiles and business parameters/policies, to handle different points of variance.

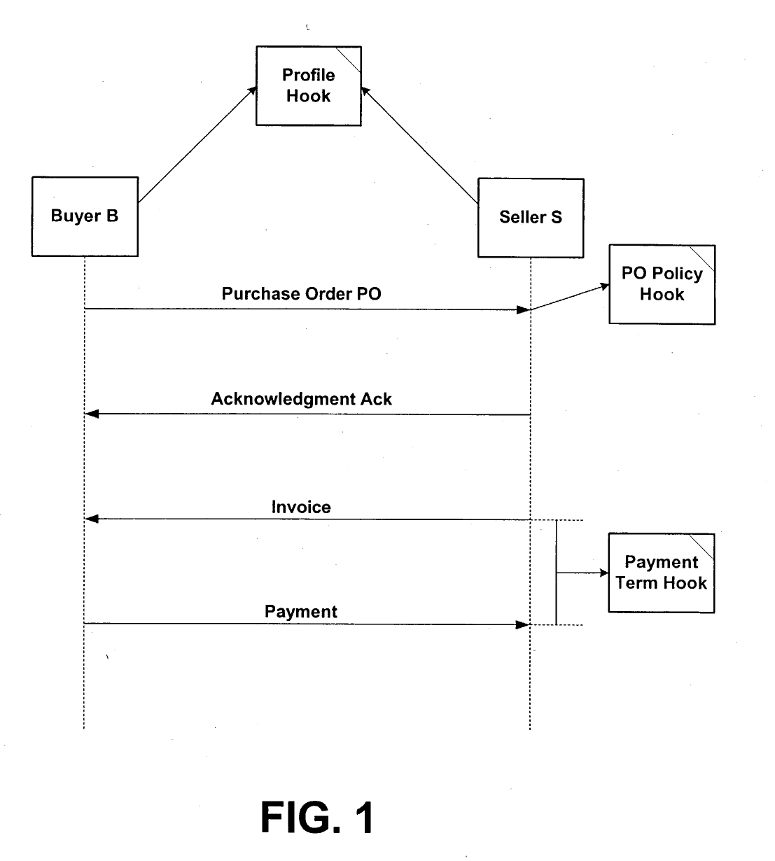

Using the dynamic business process configuration capabilities provided by the invention, ISVs, industry specialists and developers can develop templatized business processes that can then be leveraged by a large number of businesses with appropriate parameters and policies to resolve their unique and ever changing business situations. For example, as shown in FIG. 1, a configurable order management business process can be developed with the invention.

As illustrated, the invention enables a process to have hooks to specify different parameters for different scenarios. For example, a user of the order management business process shown can configure the business process to handle two different scenarios with two different partners. Thus, for instance, when dealing with Customer A, the value of these parameters can be set as: Partner=“Customer A”, PO Confirmation Time Out=2 days and Payment Terms=“2% Net 30”. Similarly, for Customer B the parameter values can be set to be: Partner=“Customer B”, PO Confirmation Time Out=3 days and Payment Terms=“1% Net 30”.

In other words, once a default order management contract is defined, it can be reused to create a multitude of partner relationships (agreements). Also, as the template is mostly a developer level artifact, it can be developed using the detailed tools required for the job by developers. The developers can then test and publish the artifact for reuse in higher level artifacts.

Exemplary Networked and Distributed Environments

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes, which may be used in connection with business process configuration. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise. In this regard, a variety of devices may have applications, objects or resources that may implicate the business process configuration of the invention.

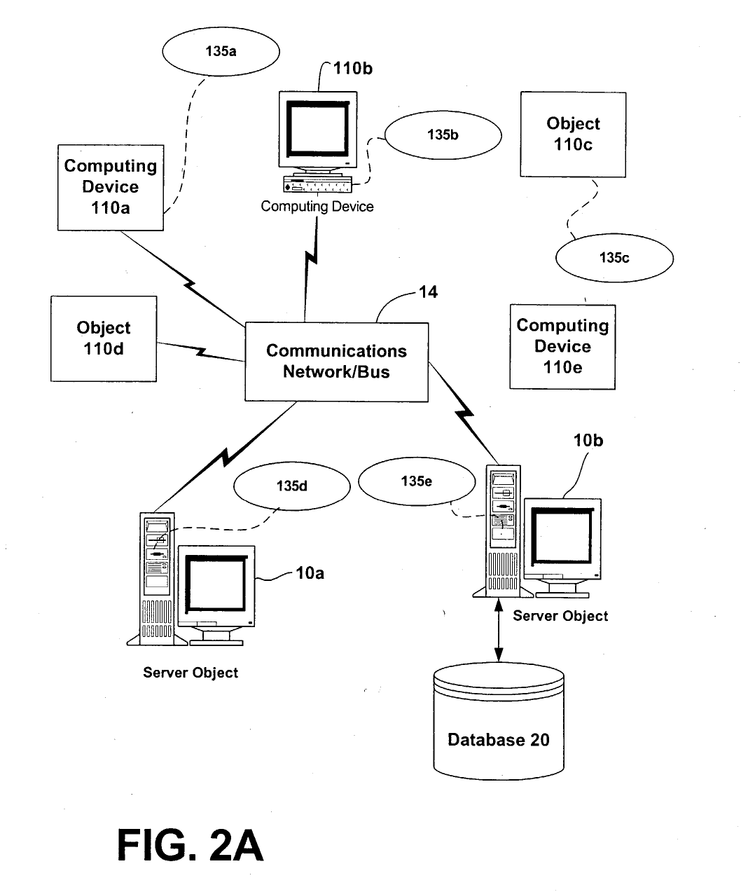

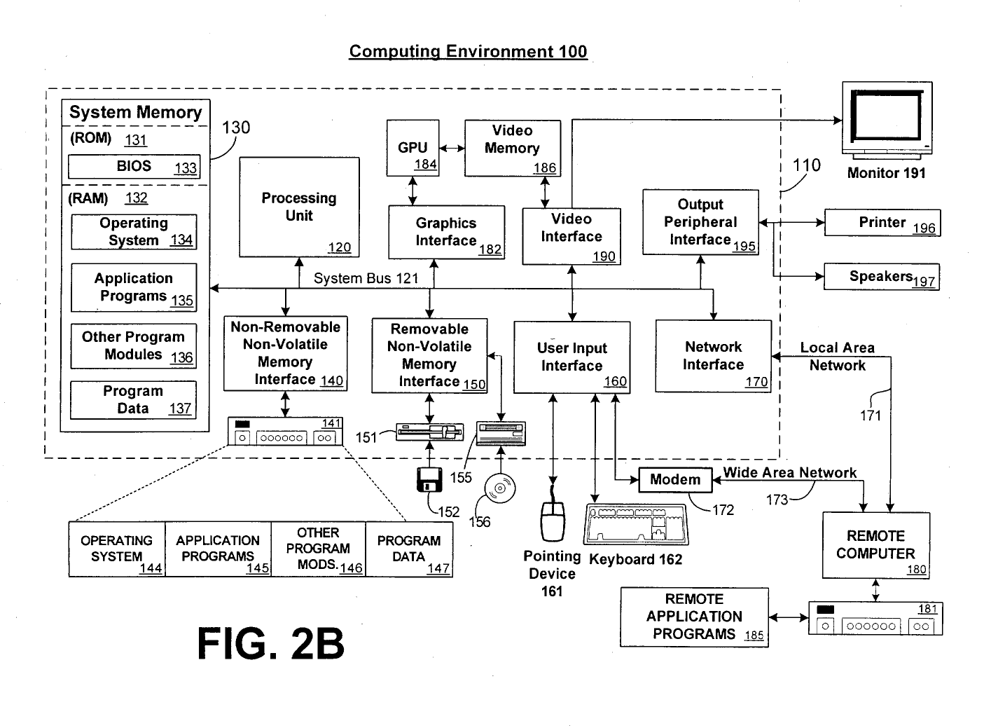

FIG. 2A provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, televisions, personal computers, etc. Each object can communicate with another object by way of the communications network 14. This network may itself comprise other computing objects and computing devices that provide services to the system of FIG. 2A. In accordance with an aspect of the invention, each object 10a, 10b, etc. or 110a, 110b, 110c, etc. may contain an application that might make use of an API, or other object, software or hardware, to request use of the business process configuration services in accordance with the invention.

In a distributed computing architecture, computers, which may have traditionally been used solely as clients, communicate directly among themselves and can act as both clients and servers, assuming whatever role is most efficient for the network. This reduces the load on servers and allows all of the clients to access resources available on other clients, thereby increasing the capability and efficiency of the entire network. Services that use the business process configuration techniques in accordance with the present invention may thus be distributed among clients and servers, acting in a way that is efficient for the entire network.

Distributed computing can help businesses deliver services and capabilities more efficiently across diverse geographic boundaries. Moreover, distributed computing can move data closer to the point where data is consumed acting as a network caching mechanism. Distributed computing also allows computing networks to dynamically work together using intelligent agents. Agents reside on peer computers and communicate various kinds of information back and forth. Agents may also initiate tasks on behalf of other peer systems. For instance, intelligent agents can be used to prioritize tasks on a network, change traffic flow, search for files locally or determine anomalous behavior such as a virus and stop it before it affects the network. All sorts of other services may be contemplated as well. Since data may in practice be physically located in one or more locations, the ability to distribute services that use the business process configuration techniques described herein is of great utility in such a system.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks.

In home networking environments, there are at least four disparate network transport media that may each support a unique protocol, such as Power line, data (both wireless and wired), voice (e.g., telephone) and entertainment media. Most home control devices such as light switches and appliances may use power line for connectivity. Data Services may enter the home as broadband (e.g., either DSL or Cable modem) and are accessible within the home using either wireless (e.g., HomeRF or 802.11b) or wired (e.g., Home PNA, Cat 5, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also emerging as digital interconnects for clusters of media devices. All of these network environments and others that may emerge as protocol standards may be interconnected to form an intranet that may be connected to the outside world by way of the Internet. In short, a variety of disparate sources exist for the storage and transmission of data, and consequently, moving forward, computing devices will require ways of sharing data, such as data accessed or utilized incident to program objects, which make use of the business process configuration techniques in accordance with the present invention.

The Internet commonly refers to the collection of networks and gateways that utilize the TCP/IP suite of protocols, which are well-known in the art of computer networking. TCP/IP is an acronym for “Transport Control Protocol/Interface Program.” The Internet can be described as a system of geographically distributed remote computer networks interconnected by computers executing networking protocols that allow users to interact and share information over the networks. Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2A, computers 110a, 110b, etc. can be thought of as clients and computer 10a, 10b, etc. can be thought of as the server where server 10a, 10b, etc. maintains the data that is then replicated in the client computers 110a, 110b, etc., although any computer could be considered a client, a server, or both, depending on the circumstances.

A server is typically a remote computer system accessible over a remote network such as the Internet. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by a protocol layer. For example, Hypertext-Transfer Protocol (HTTP) is a common protocol that is used in conjunction with the World Wide Web (WWW). Typically, a computer network address such as a Universal Resource Locator (URL) or an Internet Protocol (IP) address is used to identify the server or client computers to each other. The network address can be referred to as a URL address. For example, communication can be provided over a communications medium. In particular, the client and server may be coupled to one another via TCP/IP connections for high-capacity communication.

Thus, FIG. 2A illustrates an exemplary networked or distributed environment, with a server in communication with client computers via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to implement dynamic business process configuration.

In a network environment in which the communications network/bus 14 is the Internet, for example, the servers 10a, 10b, etc. can be Web servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment. Communications may be wired or wireless, where appropriate. Client devices 110a, 110b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135 and with connections or access to various types of storage elements or objects, across which files may be stored or to which portion(s) of files may be downloaded or migrated. Any computer 10a, 10b, 110a, 110b, etc. may be responsible for the maintenance and updating of a database 20 or other storage element in accordance with the present invention, such as a database or memory 20 for storing data processed according to the invention. Thus, the present invention can be utilized in a computer network environment having client computers 110a, 110b, etc. that can access and interact with a computer network/bus 14 and server computers 10a, 10b, etc. that may interact with client computers 110a, 110b, etc. and other like devices, and databases 20.

Exemplary Computing Device

FIG. 2B and the following discussion are intended to provide a brief general description of a suitable computing environment in which the invention may be implemented. It should be understood, however, that handheld, portable and other computing devices and computing objects of all kinds are contemplated for use in connection with the present invention. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved is a desirable, or suitable, environment for operation of the techniques for business process configuration data in accordance with the invention.

Although not required, the invention can be implemented via an operating system, for use by a developer of services for a device or object, and/or included within application software that operates in connection with business process configuration in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 2B thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 2B, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2B illustrates operating system 134, application programs 135, other program modules 136, and program data 137.

The computer 110 may also include other removable/non-removable, volatile/nonvolatile computer storage media. By way of example only, FIG. 2B illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2B provide storage of computer readable instructions, data structures, program modules and other data for the computer 110. In FIG. 2B, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186, wherein the application variables of the invention may have impact. GPUs 184, however, are but one example of a coprocessor and thus a variety of coprocessing devices may be included in computer 110, and may include a variety of procedural shaders, such as pixel and vertex shaders. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2B. The logical connections depicted in FIG. 2B include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2B illustrates remote application programs 185 as residing on memory device 181. It will be appreciated that the network connections shown are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET platform includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web sites, enabled by greater use of XML rather than HTML, (3) online services that feature customized access and delivery of products and services to the user from a central starting point for the management of various applications, such as e-mail, for example, or software, such as Office .NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform integration features as well.

As part of the .NET Framework, the Common Language Runtime (CLR) is a managed execution environment with programming that manages the execution of programs written in any of several supported languages, allowing them to share common object-oriented classes written in any of the languages. A program compiled for the CLR does not need a language-specific execution environment and can easily be moved to and run on any system. Thus, for example, programmers writing in any of Visual Basic, Visual C++, C#, etc. can compile their programs into an intermediate form of code called Common Intermediate Language (CIL) in a portable execution (PE) file that can then be managed and executed by the CLR. The programmer and the environment specify descriptive information about the program when it is compiled and the information is stored with the compiled program as metadata. Metadata, stored in the compiled program, tells the CLR what language was used, its version, and what class libraries will be needed by the program. Thus, for instance, the CLR allows an instance of a class written in one language to call a method of a class written in another language.

While some exemplary embodiments herein are described in connection with software residing on a computing device, one or more portions of the invention may also be implemented via an operating system, application programming interface (API) or a “middle man” object, a control object, hardware, firmware, etc., such that the methods may be included in, supported in or accessed via all of .NET's languages and services, and in other distributed computing frameworks as well.

Systems and Methods for Providing Dynamic Business Process Configuration

The systems and methods for providing dynamic business process configuration of the invention allow developers to introduce points of variances (parameters/policies) at well-defined places in business processes. The values of these parameters/policies are dependent on the context in which the business process is executed. This context can be defined and modified by business users after deployment based upon the changing needs of the business. The invention allows the same business processes to be utilized in different contexts without recompilation and involvement of development resources.

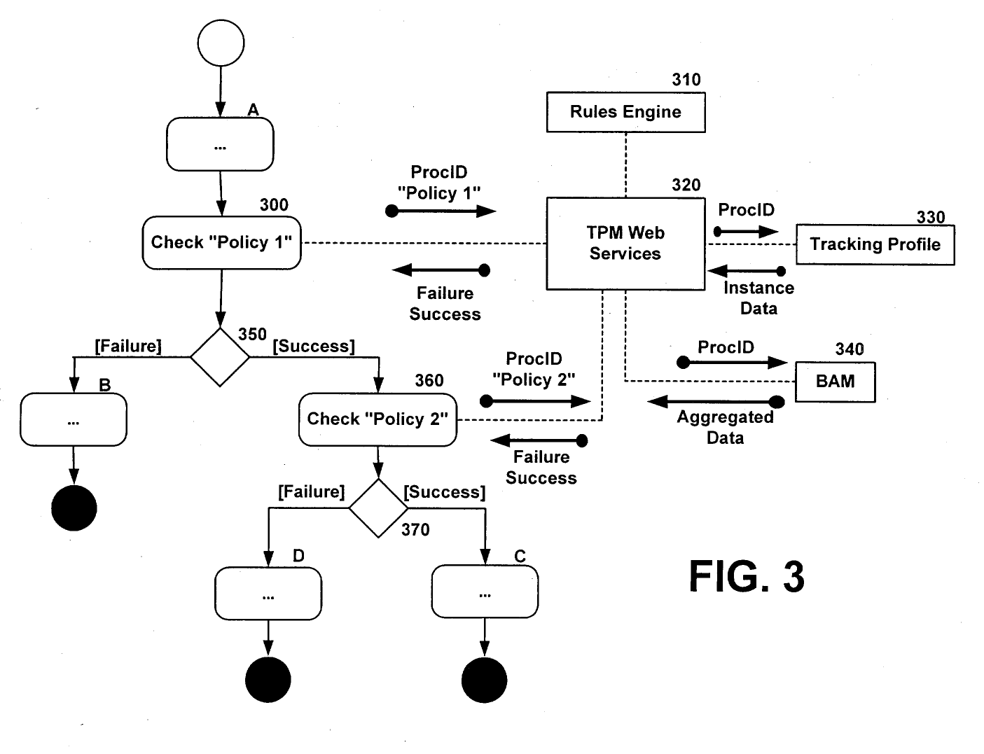

In one embodiment, the invention provides a set of web services which support the execution of policies based on a context and policy name. The context can be passed from the business process. The web service(s) execute the business policies utilizing the underlying server platform. FIG. 3 illustrates an exemplary diagram showing how policies can be checked. A, B, C and D represent portions of the flow diagram which could represent a variety of actions, and thus details are left to the business process being modeled. Policy checks occur at 300 and 360. A policy check includes sending a process ID ProcID to the set of Web services 320 connected to a rules engine 310. In this regard, instance data can be collected vis-a-vis tracking profile 330 and aggregated data can be collected vis-a-vis BAM 340. Decision points 350 and 370 guide the flow following the evaluation of the relevant policy.

The execution of configuration can result in several possible outcomes including, for example, no violation, an exception wherein a business processes need to be abandoned and an exception process needs to be started with a partner, an alert wherein a business process continues as planned and an alert is generated to inform internal users that a policy has been violated and an internal error wherein a business process is abandoned and an internal error process is then started.

Examples of the types of hooks/parameters that are supported by the invention include simple parameters, configuration based on instance data and configuration based on aggregate data. Simple Parameters include such things as single value constants, e.g., “minimum purchase order amount=$100,” multi-value enumerations, e.g., “allowed carriers={FedEx, UPS),” time, e.g., “maximum time between purchase order and confirmation=5 days,” etc. Configuration based on instance data includes, for example, configurable parameter(s) such as “Maximum Purchase Order Amount=$100,000.” Configuration based on aggregate data includes, for example, configurable parameter(s) such as “Maximum Purchase Orders per Month=100.”

In one embodiment, the business process configuration systems and methods of the invention are implemented via named parameters, which are available to a schedule designer through a CLR object call. This .NET component provides access to parameter values by name, partner name and service name. Conceptually, parameters can be represented using the following schema shown in the following Table I:

TABLE I
Exemplary Non-Limiting Schema for Business Process Configuration
Parameters

| Parameter | | BizTalk | | |
|---|---|---|---|---|
| name | Service name | Alias | Partner name | Value |
| Max PO | PO process | OpenSpace1 | Tri City Loans | 300,000 |
| amount | | | | |
| Valid date | NULL | NULL | Tri City Loans | Jan. 1, 2002 |

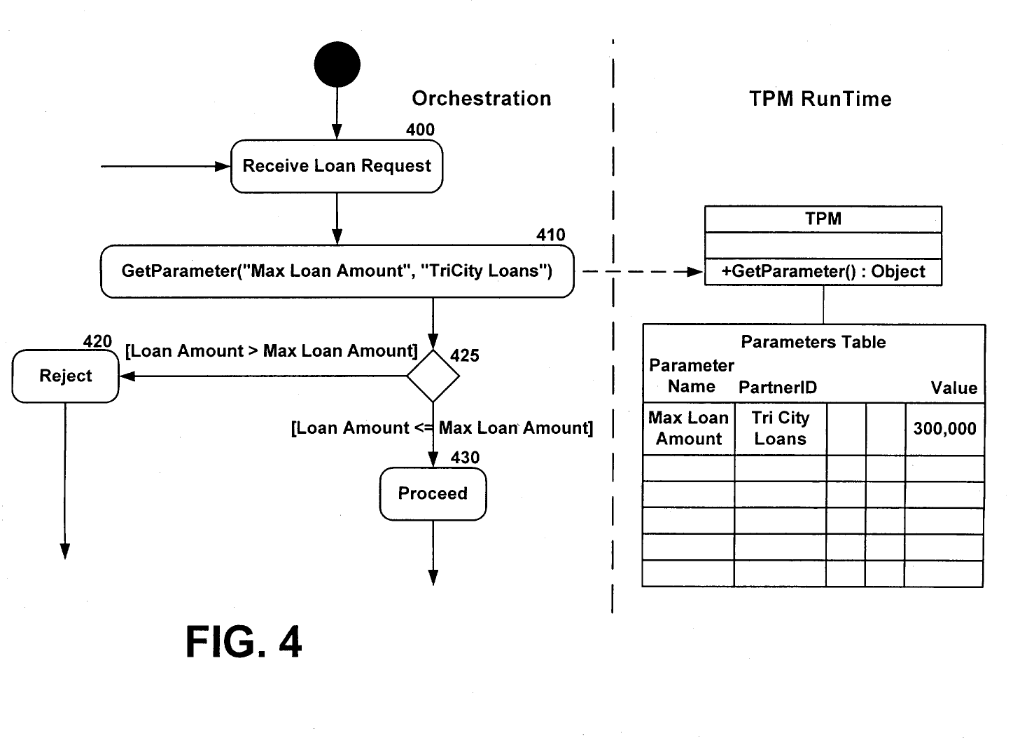

Actual parameter values are specified by business managers using trading partner management (TPM) interface. During execution, see e.g., FIG. 4, the schedule performs a call and receives actual parameter value(s) based on parameter name, partner name and an optional service name. Thus, at 400, for instance, a loan request is received. At 410, a GetParameter function call is made with parameter name and partner name. From there, at 425, a decision is made against the max loan amount policy, as to whether to reject at 420, or proceed at 430.

There are two types of parameters: global and process-specific. Global parameters are specified when either new partner is added or existing partner is modified. A process-specific parameter is specified during agreement creation and agreement modification. Agreements are explained in more detail below.

At development time, in one non-limiting embodiment, parameters are defined using a standard Orchestration Designer (OD) parameters window. Once a parameter is defined, the developer can place a call inside the schedule to a TPM component using standard .NET call mechanisms available in OD. In one embodiment of the invention, the TPM component receives the following parameters: parameter name, partner name and service name (optional). FIG. 4 illustrates the operation of an exemplary runtime parameter retrieval as defined by the following pseudocode: Object GetParameter(string parameterName, string partnerName, string serviceName). The parameters can also be implemented as rule-based policies.

The system of the invention supports creation of the following types of configurations: (A) Configuration based on instance data of a single running process. This includes rules based on single document such as “Purchase Order value should be higher than $100,000,” “The allowed carriers for a Purchase Order are FedEX and UPS” and rules based on multiple documents such as “Purchase Order Acknowledgement Amount should be equal or less than Purchase Order Amount” and “The carrier in Purchase Order Acknowledgement should be the same as the carrier in Purchase Order,” (B) Configuration based on calculations of instance data of a single running process. This includes rules based on single document such as “Purchase Order total should be equal to sum of line items in the purchase order,” “Line item total within the purchase order should be equal to number of items multiplied by the total,” and rules based on multiple documents such as “Payment amount should be equal to invoice amount minus discount,” (C) Configuration based on inference rules such as “If Invoice amount<100,000 volume discount is 3% Else volume discount is 4%” and “If the time difference between payment and invoice is less than 30 days Discount amount in Payment should be 2%” and (D) Configuration based on metrics and KPIs (aggregate and non-aggregate) such as “Sum of all purchase order amounts in a month should be greater than $100,000” and “Number of purchase orders submitted in a month should be less than 5.”

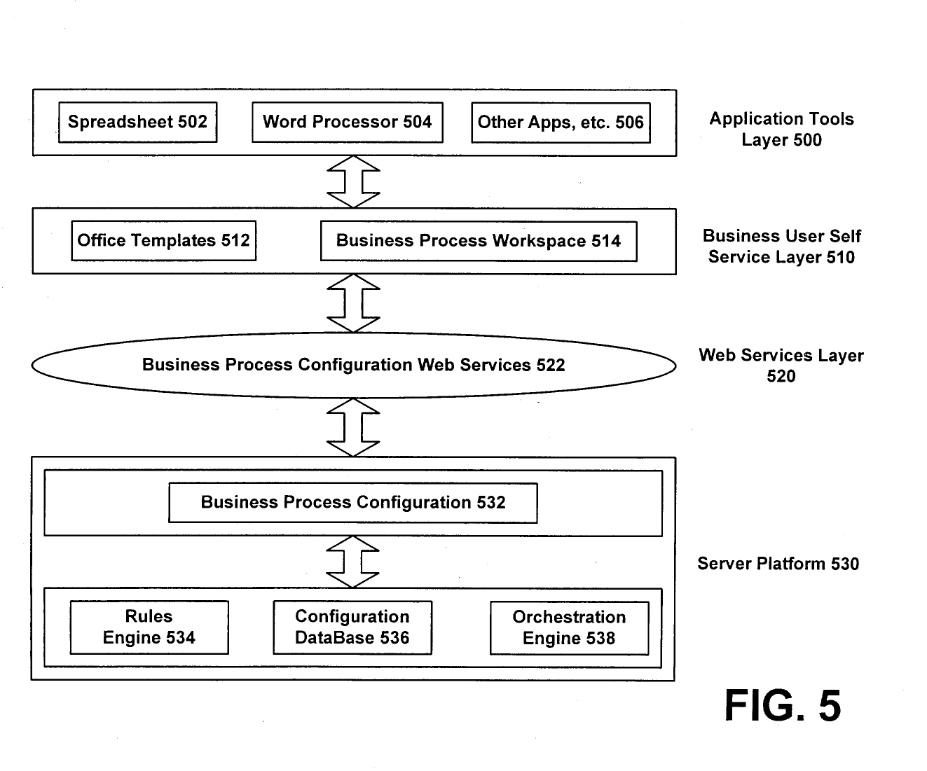

FIG. 5 shows architectural components of an exemplary arrangement of the Business Process Configuration Architecture in accordance with the invention. An application tools layer 500 interacts with a business user self service layer 510, which interacts with the web services layer 520, which interacts with the server platform 530. The application tools layer 500 includes, for example, a spreadsheet 502, a word processor 504 and other applications 506. The business user self service layer 510 includes templates 512 and business process workspace 514. The web services layer 520 includes the business process configuration web services 522. The server platform 530 includes business process configuration component 532 interacting with rules engine 534, configuration database 536 and orchestration engine 538.

Business users configure business processes (parameters and policies) using default office tools, such as Excel, Word and InfoPath. To create these documents, out of the box templates can be provided, such as Microsoft® Office® templates. The templates include the business logic required to guide the user through the process of filling in different parameters. Additional templates can be built by ISVs to fulfill unique industry requirements.

In one embodiment, these templates are housed inside a business user self service environment built on SharePoint Team Services (STS) technology. In this embodiment, the STS site and Office tools acts as front-end to Business Processes and allow business users to configure and collaborate around business processes by navigating to appropriate places. Office is utilized herein as one example of a set of applications that can be used with the invention.

The Office tools and STS bind to business process configuration Web services which allow business users to interact with underlying platform. Business Process Configuration services allow business users to configure and manage lower level orchestration artifacts via parameters and policies. In this approach, developers or ISVs define business processes in a manner so that they can be configured via business policies and parameters. Once these configurable business processes are made available, business users can adapt them to fulfill the needs of business.

The business process configuration web services provide a layer of abstraction over the underlying infrastructure so that business users interact with higher level abstractions that make sense to them without bothering about complex lower level infrastructure.

Policies and Parameters

Dynamic process configuration satisfies the following characteristics: easy definition, discoverability and run-time binding. With respect to easy definition, points of variance (POVs) are easy to define, using tools and standards available in the platform. With respect to discoverability, a point of variance should be easily discoverable by tools, i.e, discoverable without having physical access to the process implementation (assembly) and also be standard-based. With respect to run-time binding, points of variance should be easy to bind to the dynamic context using mechanisms already available in the platform.

In one embodiment, the invention supports the above characteristics by implementing as follows: POVs for policies and parameters are declared as service links that have a type name that conforms to the following pattern: (1) the service link type name ends with PolicyType suffix, e.g., MaxLoanAmountPolicyType, (2) the part of the service link type name that precedes policy suffix is treated as policy name. For example, service link type MaxLoanAmountPolicyType defines policy with name MaxLoanAmount and (3) a service link has one role, called PolicyConsumer. The process implementation initializes this service link as it uses the service link by direct assignment to DestinationParty property, for example:

servicelink uses MaxLoanAmountPolicyType MaxLoanAmountpolicy;

MaxLoanAmountPolicy(DestinationParty)=new Microsoft.XLANGS.Party( “Cell Phones R US”, “OrganizationName”);

The PolicyConsumer role has a port called TPPolicyWS. The TPPolicyWS port has an operation called GetParameter.

The following is exemplary code illustrating how POVs are declared in an exemplary business process:

```
module PurchasingService
{
  ...
    // Define a service link type for maximum loan amount policy
  public servicelinktype MaxLoanAmountPolicyType
  {
    PolicyConsumer
    {
      PurchasingService.localhost.TPMPolicyWS
    };
  };
  public service LoanProcess
  {
    servicelink uses MaxLoanAmountPolicyType.PolicyConsumer
        MaxLoanAmountPolicy;
    message LoanProcess.localhost.TPMPolicyWS_.GetPolicy_request
        MaxLoanAmountRequest;
    Message LoanProcess.localhost.TPMPolicyWS_.GetPolicy_{—}
    response
        MaxLoanAmount;
    body ( )
    {
        ...
        MaxLoanAmountPolicy(DestinationParty) =
        newParty(partnerName,
          “OrganizationName”);
    construct MaxLoanAmountRequest
    {
            MaxLoanAmountRequest.partnerId = partnerId;
            MaxLoanAmountRequest.policyId = “MaxPOAmount”;
            maxPOAmountRequest.processId = “LoanService”;
    }
        // Get maximum loan amount for current partner
    send (MaxLoanPolicy
          [LoanService.localhost.TPMPolicyWS].GetPolicy,
            maxLoanRequest);
    receive (MaxLoanPolicy
          [LoanService.localhost.TPMPolicyWS].GetPolicy,
            maxLoanAmount);
        ...
    }
  }
}
```

Discoverability and Binding

Communication of a business process with the outside world is achieved via messages through ports and operations. Ports and operations are defined by developers at design-time and bound to recipients during configuration time. Ports are easily discoverable through standard-based WSDL documents. It is clear that ports satisfy all requirements of points of variances listed above. In order to use ports as points of variance, one defines a convention according to which all ports that conform to a certain pattern are treated. Following this model, all ports that are “declared” as points of variance are bound to the TPM Web Service that provides context sensitive values for configured policies. Policy values are configured by the system users through agreements. Agreements are based on descriptions of processes deployed in the system. These descriptions include, among others, definitions of ports that define points of variance. This makes it possible to present points of variance in any process to a user just by parsing the process's WSDL and identifying policy callouts by matching the port'signature.

Agreements

As mentioned above, in accordance with the invention, business users can tailor a business process by creating or modifying an agreement for different scenarios after deployment, as needed, without recompiling or re-building the business process. Agreements are used to (re)configure deployed business process. They define the values of point of variances for a business process for a specific set of participants.

In one embodiment, some non-limiting API commands provided by the invention to first discover business process associated point of variances include: GetParameters. GetParameters returns the point of variances defined on a particular business process.

In addition, some non-limiting API commands provided by the invention for operating in connection with such agreements include: CreateAgreement, DeleteAgreement, UpdateAgreement, ActivateAgreement and DeactivateAgreement, GetAgreement and GetAgreementList.

The CreateAgreement API adds a new agreement to the TPM system. The details of Agreement are defined in the Agreement schema and wizard below. The agreement specifies which participants will perform which role in a particular business process and what will be the values of point of variances of this business process for these participants. In one embodiment, a new agreement is not activated by default. An agreement is explicitly activated. Once activated the values of point of variances can be changed at run-time without de-activation. The API supports an optional tpmStsUrl parameter for passing the URL of a TPM STS site. TPM maintains consistency between data in the TPM database and data in the TPM STS site by calling STS APIs to update list item information when the corresponding TPM entity is modified. The agreement parameter includes complete information about the new agreement.

The DeleteAgreement API deletes an agreement from the TPM system. The optional tpmStsUrl parameter is used to pass the URL of a TPM STS site. TPM maintains consistency between data in the TPM database and data in the TPM STS site by calling STS APIs to update list item information when the corresponding TPM entity is modified. The agreementId argument specifies the existing agreement for deletion.

The UpdateAgreement API is used to update information about a complete agreement entity. The optional tpmStsUrl parameter is used to pass the URL of a TPM STS site. TPM maintains consistency between data in the TPM database and data in the TPM STS site by calling STS APIs to update list item information when the corresponding TPM entity is modified. This agreement parameter includes complete information about a complete agreement.

The ActivateAgreement APT activates an existing agreement. Agreement activation results in automatic agreement partner enlistment with the service role referenced by activated agreement. The optional tpmStsUrl parameter is used to pass the URL of a TPM STS site. TPM maintains consistency between data in the TPM database and data in the TPM STS site by calling STS APIs to update list item information when the corresponding TPM entity is modified. The agreementId parameter is used to specify an ID of an existing agreement.

The DeactivateAgreement API deactivates an existing agreement. Agreement deactivation unenlists an agreement partner from the party type referenced by the agreement. The optional tpmStsUrl parameter is used to pass the URL of a TPM STS site. TPM maintains consistency between data in the TPM database and data in the TPM STS site by calling STS APIs to update list item information when the corresponding TPM entity is modified. The agreementId parameter is used to specify the ID of an existing active agreement.

The GetAgreement API returns complete information for an agreement specified by a partnerInfo structure. The agreementId parameter identifies an existing agreement. If successful, this operation returns an agreement structure that contains complete agreement information.

The GetAgreementList API returns an AgreementList message containing list of keys of agreements that match the conditions specified in the arguments. An optional parameter groupOrPartnerId is used to specify that only agreements related with a given partner or group are returned. If this parameter is not specified, then a list of all agreements is returned. This API returns AgreementList on success. Agreementlist is a collection of agreementInfo structures that contain information about each matching agreement, including the ID. Using this ID, the client application can retrieve a full agreement document from AgreementInfo.

The following Table II illustrates what an exemplary non-limiting XML schema for an agreement might look like in accordance with an embodiment of the invention.

TABLE II
Agreement XML Schema

```
<?xml version=“1.0” encoding=“UTF-8” ?>
<!-- edited with XML Spy v4.1 U (http://www.xmlspy.com) by Raza Syed
(Microsoft Inc) -->
<xs:schema targetNamespace=“http://www.microsoft.com/bizoffice”
xmlns:xs=“http://www.w3.org/2001/XMLSchema”
xmlns=“http://www.microsoft.com/bizoffice”
elementFormDefault=“qualified”
attributeFormDefault=“unqualified” version=“1.0”>
    <xs:include schemaLocation=“Addendum.xsd” />
    <xs:redefine schemaLocation=“partner.xsd” />
    <xs:element name=“Agreement”>
        <xs:annotation>
            <xs:documentation>Trading Partner Agreement defines
relationship between partners. It specifies the partners, duration of their
relationship, various addendums referenced and exception
contacts.</xs:documentation>
        </xs:annotation>
        <xs:complexType>
            <xs:sequence>
                <xs:element name=“AgreementId”
                    type=“xs:anyURI”>
                    <xs:annotation>
                        <xs:documentation>Unique Identifier of
Parameter</xs:documentation>
                    </xs:annotation>
                </xs:element>
                <xs:element name=“Names” type=“NamesType”
minOccurs=“0” />
                <xs:element name=“Description” minOccurs=“0” />
                <xs:element name=“AgreementDate” type=“xs:date”
minOccurs=“0” />
                <xs:element name=“Duration” minOccurs=“0”>
                    <xs:annotation>
                        <xs:documentation>Duration for which
Agreement is effective</xs:documentation>
                    </xs:annotation>
                    <xs:complexType>
                        <xs:sequence>
                            <xs:element name=“StartDate”
type=“xs:date” minOccurs=“0” />
                            <xs:element name=“EndDate”
type=“xs:date” minOccurs=“0” />
                        </xs:sequence>
                    </xs:complexType>
                </xs:element>
                <xs:element name=“Partners”>
                    <xs:annotation>
                        <xs:documentation>Partners involved in
TPA</xs:documentation>
                    </xs:annotation>
                    <xs:complexType>
                        <xs:sequence maxOccurs=“unbounded”>
                            <xs:element name=“PartnerInfo”
type=“PartnerInfo” />
                        </xs:sequence>
                    </xs:complexType>
                    <xs:unique name=“PartnerIdUnique”>
                        <xs:selector xpath=“Partner” />
                        <xs:field xpath=“PartnerId” />
                    </xs:unique>
                </xs:element>
                <xs:element name=“Addendums”
                type=“AddendumsType” />
                <xs:element name=“LegalTerms”
                type=“LegalTermsType”
minOccurs=“0” />
            </xs:sequence>
                <xs:attribute name=“schemaVersion”
                type=“xs:decimal”
use=“required” />
        </xs:complexType>
    </xs:element>
    <xs:complexType name=“PartnerInfo”>
        <xs:complexContent>
            <xs:extension base=“Partner”>
                <xs:sequence>
                    <xs:element name=“AddendumRoles”
type=“AddendumRolesType” minOccurs=“0” />
                </xs:sequence>
            </xs:extension>
        </xs:complexContent>
    </xs:complexType>
    <xs:complexType name=“AddendumRolesType”>
        <xs:sequence>
            <xs:element name=“AddendumRole”
            maxOccurs=“unbounded”>
                <xs:complexType>
                    <xs:sequence>
                        <xs:element name=“AddendumId” />
                        <xs:element name=“RoleId” />
                    </xs:sequence>
                </xs:complexType>
            </xs:element>
        </xs:sequence>
    </xs:complexType>
</xs:schema>
```

Some other non-limiting API commands provided by the invention include: GetPartnerList, GetGroupList, GetParentGroupList, GetServiceList, GetRegistrationList, GetPartner, GetGroup, GetRegistration, GetServiceDetails, CreatePartner, CreateGroup, CreateRegistration, DeleteRegistration, DeletePartner, DeleteGroup, UpdatePartner, UpdateGroup, UpdateRegistration, AddToGroup, RemoveFromGroup, DeployPartner and UndeployPartner.

The getPartnerList API returns a PartnerList message including list of keys of partners that match the conditions specified in the arguments. Arguments include parentGroupId that identifies an existing parent group and from, rowCount. From and rowCount are optional long integer parameters allowing the requesting program to limit the number of results returned. This API returns a message of PartnerList type. This list includes partnerInfo structures.

The GetGroupList API receives argument parentGroupId identifying an existing parent group and returns a GroupList structure. The group list is a collection of groupInfo elements that includes information about each matching group.

The GetParentGroupList API receives a recursive argument, an optional Boolean parameter indicating if only immediate parent groups should be searched or full transitive closure and a partnerOrGroupId parameter identifying existing group item (parent or group) whose parent groups are searched for, and returns a GroupList structure, i.e., a collection of groupInfo elements that include information about each matching group.

The GetServiceList API is used to retrieve a list of all services deployed on registered server. The result includes complete interface information for every service. Arguments include ServerRegistrationId, a parameter identifying existing server registration and it returns a ServiceList message, which includes zero or more ServiceDetails structures.

The GetRegistrationList API receives no arguments and returns a btsRegistrationList message. The registration list includes btsRegistrationList structures.

The GetPartner API returns complete information for partner specified by partnerInfo structure, and receives a partnerID argument identifying an existing partner and returns a Partner structure that includes complete partner information.

The GetGroup API returns complete information for a group specified by groupInfo structure, receiving a groupId argument identifying an existing group and returning a group structure that includes complete group information.

The GetRegistration API returns complete information for an agreement specified by a RegistrationInfo structure, and receives a RegistrationInfo argument, a parameter including information about an existing agreement and returns a Registration structure that includes complete registration information.

The GetServiceDetails API returns complete information for a service specified by a passed serviceId, a parameter identifying a service deployed on the server and a RegistrationId, a parameter identifying the server, returning a ServiceDetails structure that includes complete service information.

The CreatePartner API creates a new partner. The state of a new partner is undeployed. If an optional STS URL is passed, then an attempt to create an item in the TPM STS partners list is made. If it fails, then the whole operation fails and returns. This API receives a tpmStsUrl parameter used to pass the URL of TPM STS site and a partner parameter that includes complete partner information. TPM maintains consistency between data in the TPM database and data in the TPM STS site by calling STS APIs to update list item information when the corresponding TPM entity is modified.

The CreateGroup API adds a new group to the TPM system. A new group requires a parent group to be specified and complete group information is passed via a group element. Arguments include the group element including complete information about group, and there is no return.

The CreateRegistration API registers a new server with the TPM system, receiving as an argument a Registration argument including complete information about the server, returning nothing.

The DeleteRegistration API is used to delete an existing server registration from the TPM system. Registration can be deleted only if no partners are deployed on the corresponding server. This function also deletes an Outbox STS document library associated with this server. This API receives a RegistrationId specifying a registration and returns nothing.

The DeletePartner API is used to delete an existing partner from TPM system, receiving a tpmStsUrl parameter used to pass the URL of TPM STS site and a partnerId that specifies the ID of an existing partner. The TPM maintains consistency between data in the TPM database and data in the TPM STS site by calling STS APIs to update list item information when the corresponding TPM entity is modified. This API returns nothing.

The DeleteGroup API is used to delete an existing group and receives a tpmStsUrl parameter used to pass the URL of TPM STS site and a groupId for specifying an existing group. The TPM maintains consistency between data in the TPM database and data in the TPM STS site by calling STS APIs to update list item information when the corresponding TPM entity is modified. This API returns some optional information.

The UpdatePartner function is used to update complete existing partner information, and receives a tpmStsUrl parameter is used to pass the URL of TPM STS site and a Partner parameter that includes complete partner information.. The TPM maintains consistency between data in the TPM database and data in the TPM STS site by calling STS APIs to update list item information when the corresponding TPM entity is modified. The Partner element includes a valid existing partner ID. This API returns some optional information.

The UpdateGroup API is used to update information about group entity and receives a tpmStsUrl parameter used to pass the URL of TPM STS site and a Group parameter including complete information about a complete group. The TPM maintains consistency between data in the TPM database and data in the TPM STS site by calling STS APIs to update list item information when the corresponding TPM entity is modified. This API returns some optional information.

A registration may be updated via the UpdateRegistration API.

This AddToGroup API is used to add group items to a group. A group item is either a partner or group. Every group item is a member of one or more group (every item is a member of “All” group, by default). This API receives a tpmStsUrl parameter used to pass the URL of TPM STS site, a groupId parameter including the id of group items being added to and a groupItemList parameter including a list of references to existing groups and partners. The TPM maintains consistency between data in the TPM database and data in the TPM STS site by calling STS APIs to update list item information when the corresponding TPM entity is modified.

The RemoveFromGroup API removes items referenced by a passed groupItemList from a group identified by groupId. Removing an item from a group does not delete item. Items cannot be deleted from an “All” global group. Arguments include a tpmStsUrl parameter used to pass the URL of TPM STS site, a groupId parameter including the id of a group item being removed from and a groupItemList parameter including a list of references to existing partners and/or groups. The TPM maintains consistency between data in the TPM database and data in the TPM STS site by calling STS APIs to update list item information when the corresponding TPM entity is modified.

The DeployPartner API is used to deploy existing partner to a server. Partners can be deployed only to a single server. In order to redeploy a partner, it has to be undeployed first and deployed, possibly to a different server, afterwards. Arguments include a tpmStsUrl parameter used to pass the URL of TPM STS site, a partnerId parameter used to specify the ID of an existing undeployed partner and a RegistrationId parameter used to specify the server to which the partner will be deployed. The TPM maintains consistency between data in the TPM database and data in the TPM STS site by calling STS APIs to update list item information when the corresponding TPM entity is modified. Upon success, this API returns the ID of a party, created in the management database.

The UndeployPartner API is used to undeploy an existing, deployed partner from a server. Arguments include a tpmStsUrl parameter used to pass the URL of TPM STS site, a partnerId parameter used to specify an ID of existing deployed partner and a RegistrationId parameter used to specify the server from which partner will be undeployed. The TPM maintains consistency between data in the TPM database and data in the TPM STS site by calling STS APIs to update list item information when the corresponding TPM entity is modified.

As mentioned, a central artifact in relationship configuration in accordance with the invention is an agreement. An agreement is a powerful artifact that builds on lower level technical artifacts to fulfill the requirements of today's dynamic business needs. The agreements are based on underlying business process and party management artifacts. The business processes can be provided by ISVs or developed by sophisticated developers to model the fixed patterns of the relationship. These business processes can expose hooks to associate appropriate organizational and user profiles. They can also provide appropriate hooks to define parameters and business policies and parameters to handle different points of variability. In addition, aggregate views can be defined on these business processes by ISVs so that additional business policies can be defined on aggregate data. Agreement creation involves configuration of business processes by associating roles with the appropriate profiles, specifying appropriate parameters and setting up appropriate business policies. The business users can define business policies based on both instance and aggregate data and can also configure the appropriate severity levels to fulfill their requirements. This allows business users to participate in business processes because business policy changes no longer require fiddling with the lower level business process artifact, which generally requires developer's help. Business users can change the business policies without needing to recompile the schedules and going through the laborious task of involving developers and consultants.

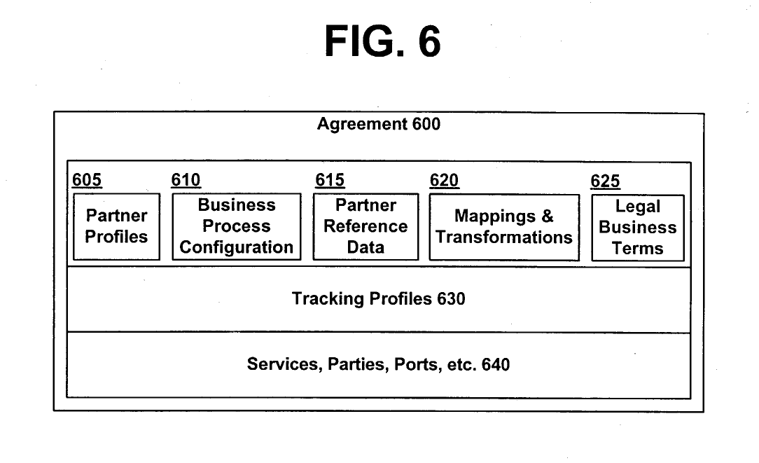

FIG. 6 shows an exemplary agreement structure 600. An agreement may include partner profiles 605, business process configuration component 610, partner reference data 615, mappings and transformations 620 and legal business terms 625. An agreement structure may also include tracking profiles 630 and services, parties, ports, etc. 640.

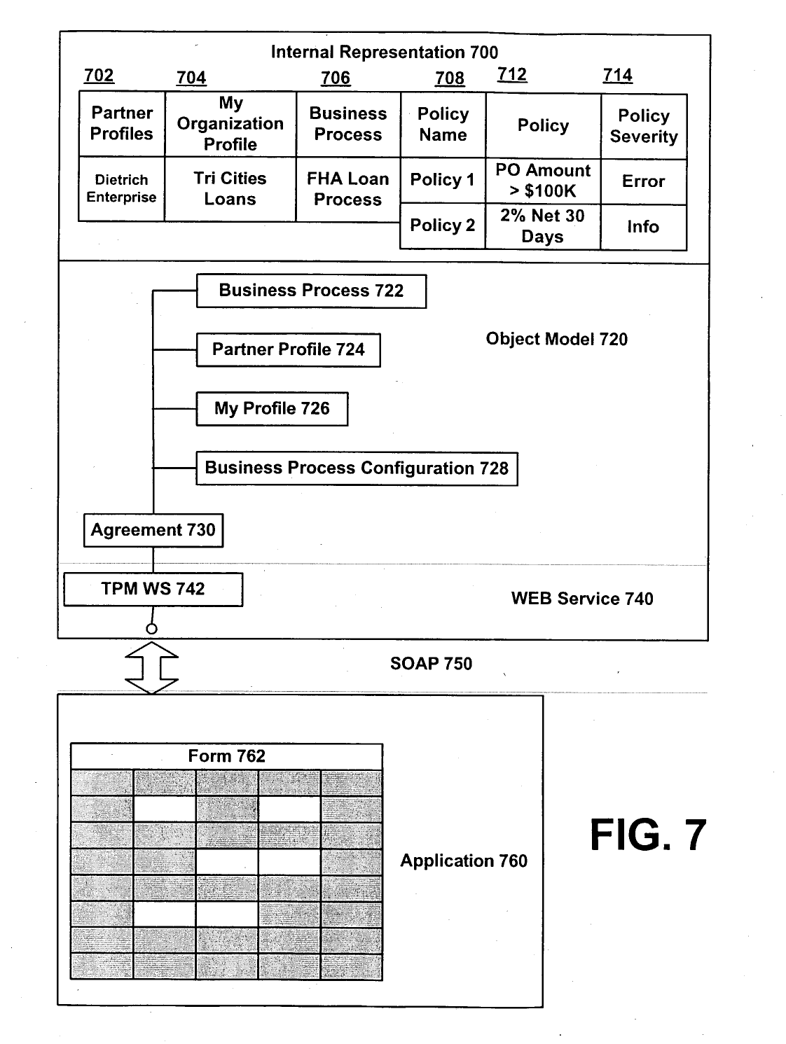

To support a trading partner relationship creation, the invention provides a Trading Partner Management Web services and agreement and partner wizards. The Web service is responsible for creation and deployment of agreements and partners. This Web service provides all the methods needed for partner relationship establishment and management as discussed above. FIG. 7 illustrates an exemplary general architecture for the Agreement system. An internal representation 700 includes partner profiles 702, a my organization profile 704, a business process 706, policy names 708, policy values 712 and policy priorities 714. The object model 720 is shown below, and includes the business process 722, the partner profiles 724, my profile 726 and the business process configuration 728, as represented via an agreement structure 730. The TPM web service 742, part of the web service layer 740 is as described above, and communicates via a protocol 750 such as SOAP with application 760, which may have a form 762 associated therewith.

In one embodiment, functionality of the TPM Web Service 742 includes, but is not limited to: (1) Create new agreement, (2) Deployment of agreements, (3) Query existing agreements, (4) Modify Agreements, (5) Role Based Access Control, (6) Un-deploy and Delete Agreements, (7) Create Partners, (8) Delete Partners and (9) Create Groups.

With respect to creating new agreements, the TPM Web Service 742 is responsible for creation of agreements. The creation process involves creation of an XML artifact and also appropriate data-structures in the partner Business Process Management database 536.

With respect to deployment of agreements, the Agreement Web Service 742 is responsible for deployment of agreements. The deployment process involves creation of appropriate partner records in the Trading Party Management system, creation of partner specific KPIs (Key Performance Indicator) and knowledge worker views, creation of appropriate subscriptions so as to allow for maximum reuse of schedules, creation of business policies and parameters STS folders.

With respect to querying existing agreements, the TPM Web Service 742 responds to a request for the contents of agreements as XML by partner names. Some of the queries may return more than one agreement.

With respect to modifying Agreements, the TPM Web Service 742 supports modification of agreements. The agreement modification includes modification of the agreement artifact and then optionally modification of the system configuration.

With respect to role based access control, access control checks are established at web service access points, establishing roles for agreement browsing, editing and approval. Appropriate access rights are granted according to those roles. The user is authenticated and authorized in order to determine the user's permissions with respect to agreement creation and deployment.

With respect to undeployment and deletion of agreements, the TPM Web Service 742 supports un-deployment of agreements. Once the agreement is un-deployed, it can be deleted from the system

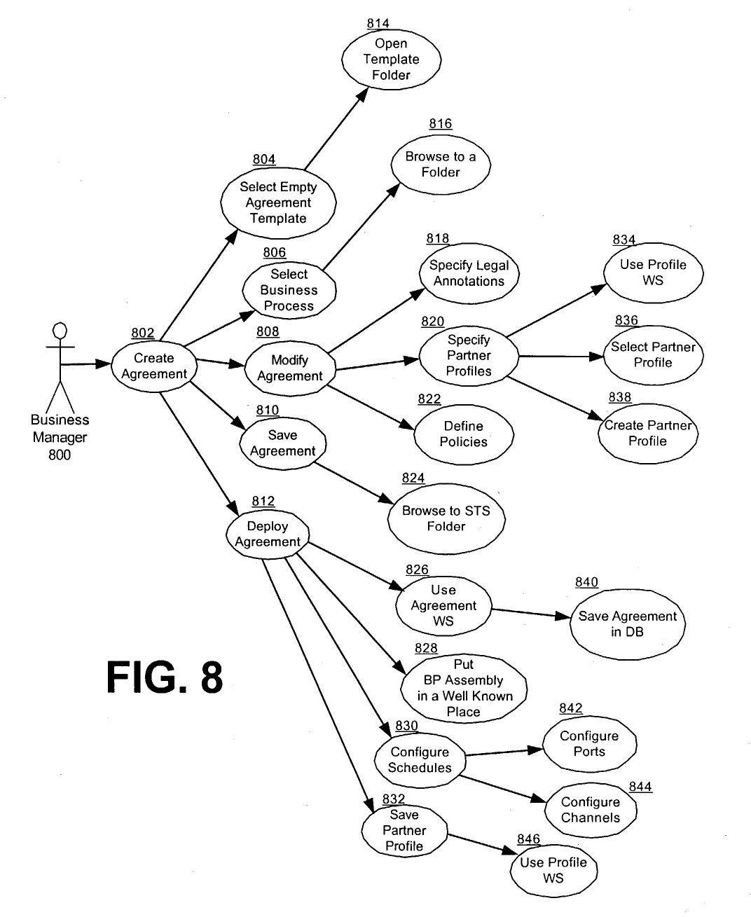

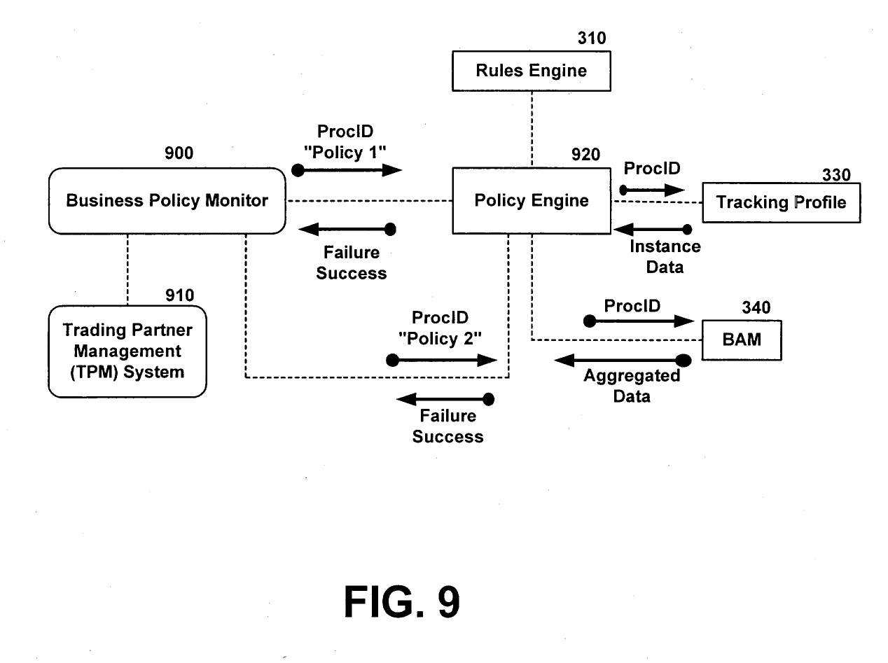

An Agreement Wizard runs inside the Office application 760, and allows creation and modification of relationships through agreements. The exemplary use-case diagram of FIG. 8 shows how agreements can be created and modified in accordance with an embodiment of the invention. In this regard, a business manager 800 creates an agreement at 802. From 802, an empty agreement template may be selected at 804 and then a template folder can be opened at 814. From 802, a business process is also selected at 806, and a folder is browsed to at 816. An agreement may be modified at 808. From 808, legal annotations may be specified at 818, and policies may be defined at 822. Additionally, from 808, partner profiles may be specified at 820. From 820, the profile web services can be used at 834, a partner profile can be selected at 836 and a partner profile can be created at 838. From 802, an agreement may be saved at 810. From 810, an STS folder may be browsed to at 824. From 802, an agreement can be deployed at 812. From 812, the agreement web service can be used at 826, from which point the agreement can be saved in the configuration database at 840. From 812, the business process assembly can be placed in a well known location at 828. From 812, schedules can be configured at 830, from which point, the ports can be configured at 842, and the channels can be configured at 844. From 812, a partner profile can be saved at 832. From 832, the TPM web service can be used at 846.

Taking into consideration the above described scenarios, requirements, justification, and value proposition, the following non-limiting features are supported for an embodiment of the agreement wizard in accordance with the invention: (1) Business process POV discovery, (2) Agreement Office Template, (3) Agreement Name, (4) Business Process Name, (6) Business Process Roles, (7) Business Policies, (8) Business/Legal Terms and (9) UI Experience for Agreements.

With respect to the agreement template, the BEU (Business End User) uses an agreement creation template when creating, reviewing or updating the agreements. The assumption is that the developer or ISV would have already created business processes and the associated knowledge worker views. The BEU loads the blank agreement template in order to create an agreement. An agreement template contains forms and business logic in it. In one embodiment, it includes: an empty agreement Name, an empty business process name, an empty section for two business process roles, an empty section for business policies and an empty business and legal terms section. The business policy section includes two sub sections: one section for defining business policies on process instances and another for defining business policies on aggregate metrics and KPIs (knowledge worker views).

With respect to agreement name, the BEU can use any descriptive agreement name. The agreement name should be unique.

With respect to business process template name, the business process template name is a drop-down list box in one embodiment. In this list box, all the available business process template names accessible to this BEU appear. The BEU selects one of the patterns on which it wishes to base the agreement

With respect to business process roles, selection of the business process pattern populates the role names in this business process template. For both these roles, the BEU can attach appropriate partner profiles.

With respect to business policies, selection of a business process template populates the policy identifier defined in this business process template. The BEU can click on each policy identifier to define a business policy. In addition, the BEU can define additional policies on aggregate data, i.e., knowledge worker views.

With respect to business/legal terms, this is a free-form section where the BEU can associate an existing application document, e.g., Word document. It also has the option of importing the terms from Word documents into the agreement XML manifest. This is an optional step and need not be done for all relationships.

With respect to the UI experience for agreements, it can be appreciated that a variety of UI experiences for agreements can be provided.

Business processes are configured via business policies and configurable parameters in accordance with the invention. To this end, the invention provides a policy service built over the rules engine, and policies are saved in the rules engine. The creation and access to policies is provided through a TPM Web Service. In one embodiment, the TPM Web Services support the following non-limiting features: (1) GetParameters for discovering parameters/policies on business processes and (2) GetParameterValue for retrieving the value of policies/parameters for a given business process and partners at run-time.

Policies can also be called from orchestration by calling the TPM Web services as shown in FIG. 3, and described above. The policy execution can result in several possible outcomes: (A) Value (B) Exception (Business processes need to be abandoned and exception process needs to be started with a partner) and (C) Alert (Business processes continue as planned and an alert needs to be fired to inform the internal users that a policy is violated).

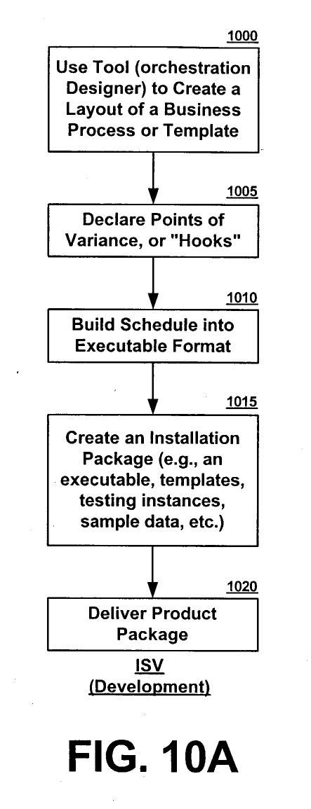

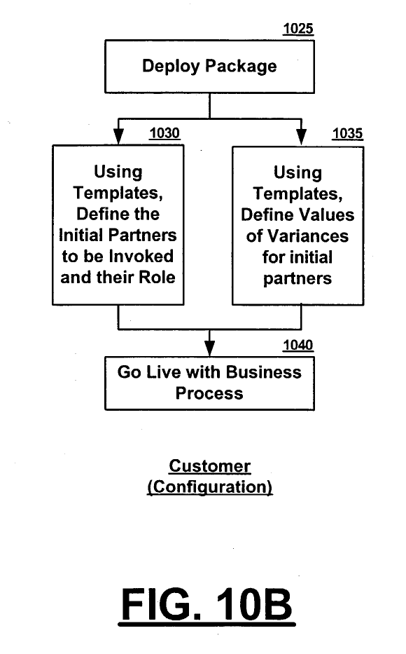

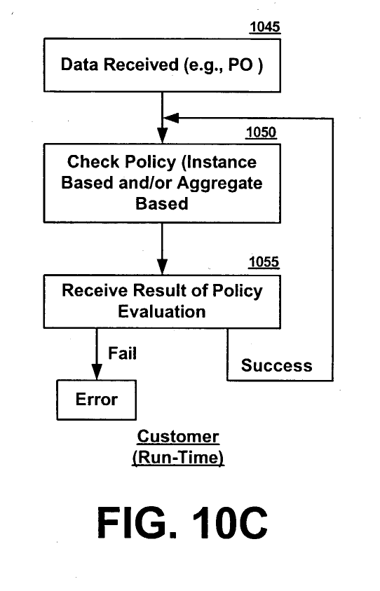

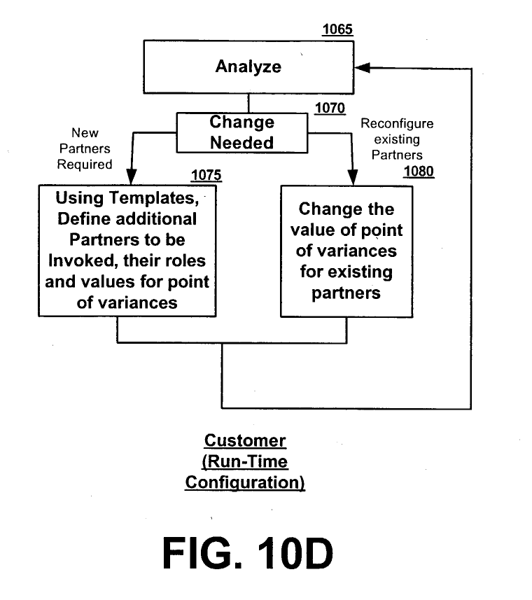

FIGS. 10A through 10D illustrate an exemplary process for utilizing the present invention from business process designer to run-time use of the dynamically configurable business process by a customer. FIG. 10A illustrates the creation of a business process installation package by a business process designer in accordance with the invention. FIG. 10B illustrates what a customer does once the customer receives the installation package. FIG. 10C illustrates exemplary aspects of the invention once the dynamically configurable business process has “gone live” at the customer site. FIG. 10D illustrates exemplary aspects of the invention of how business process can be dynamically configured without redeployment after it has “gone live” at the customer site.

FIG. 10A illustrates that the present invention provides a tool by which a business process designer can model a business process, by a laying out the business process and providing corresponding templates at 1000. At 1005, the designer introduces appropriate points of variance, or hooks into the business process, thereby introducing a configurable dimension to the business process being modeled. At 1010, the schedule is built into an executable format, and at 1015, an installation package is generated including such things as the executable, the templates, testing instances, sample data, etc. in order to make the deliverable user friendly and testable. At 1020, the ISV, or business process designer, delivers the package to the customer.

FIG. 10B illustrates that with the templates and executable provided in the package, the customer deploys the package at 1025, and at 1030 and 1035, easily defines partners for the business process and their respective roles, and provide values of the variances, or hooks, providing different values for different partners where appropriate. Once the partners and variance values are input, the customer can go live with the business process at 1040, keeping in mind that at any time that the customer's business needs change, the set of web services APIs provided by the invention enable the customer to modify partner relationships, roles, values for variances, add partners, remove partners, and so on, as described in more detail above in connection with the APIs provided by the invention.

FIG. 10C illustrates exemplary aspects of the live, dynamically configurable business process. As mentioned, the customer can modify aspects of the business process as the system is running. At 1045, data input, such as a purchase order is received. At 1050, the policies for the business process are checked, as described in detail above. At 1055, as a result of the evaluation, either a policy failure results, invoking an error, or success is achieved and the flow returns. FIG. 10D illustrates exemplary aspects of the live, dynamically configurable business process. As mentioned, the customer can modify aspects of the business process as the system is running. At 1065, a business end user analyzes its business process. At 1070, it realizes that a change is required. In 1080, it realizes that it can fulfill the change needs simply by modifying an existing policy via an existing agreement without redeployment. In 1075, it realizes that it needs to add a new partner to the process with its own defaults for point of variances (policies) without redeploying the business process.

There are multiple ways of implementing the present invention, e.g., an appropriate API, tool kit, driver code, operating system, control, standalone or downloadable software object, etc. which enables applications and services to use the business process configuration methods of the invention. The invention contemplates the use of the invention from the standpoint of an API (or other software object), as well as from a software or hardware object that communicates in connection with business process configuration data. Thus, various implementations of the invention described herein may have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which it is desirable to implement business process configuration. Thus, the techniques for encoding/decoding data in accordance with the present invention may be applied to a variety of applications and devices. For instance, the algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. With respect to embodiments referring to the use of a control for achieving the invention, the invention is not limited to the provision of a .NET control, but rather should be thought of in the broader context of any piece of software (and/ore hardware) that achieves the configuration objectives in accordance with the invention. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the dynamic business process configuration techniques of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for providing dynamic business process configuration, comprising:
modeling a business process with a dynamically configurable business process model including inserting at least one point of variance into the business process model; and
generating at least one file for implementing said business process based on said business process model,
wherein said at least one point of variance specifies a point in the business process that is configurable.

2. A method according to claim 1, wherein said business process model enables the same business process to be utilized in different contexts without recompilation and without involvement of development resources.

3. A method according to claim 1, further comprising:
generating at least one template for the entry of data relating to said business process.

4. A method according to claim 1, wherein said data includes at least one of partner data, policy value data and data relating to the at least one point of variance.

5. A method according to claim 1, wherein said at least one point of variance is dependent on a context in which the business process is executed.

6. A method according to claim 1, wherein said at least one point of variance includes at least one of a simple parameter, a configuration point based on instance data.

7. A method according to claim 1, wherein said at least one point of variance includes at least one of a global parameter and a process-specific parameter.

8. A method according to claim 7, wherein global parameters are specified when either a new partner is added or an existing partner is modified and a process-specific parameter is specified during an agreement creation or agreement modification process.

9. At least one of an operating system, driver code, an application programming interface, a tool kit and a processing device for performing the method of dynamic configuration of claim 1.

10. A modulated data signal carrying computer executable instructions for performing the method of claim 1.

11. A computer readable medium comprising computer executable instructions for performing the method of claim 1.

12. A method for deploying at least one file for implementing a dynamically configurable business process based on a business process model having at least one point of variance inserted therein, comprising:
entering data into at least one template for the entry of data relating to said business process including at least one of partner data, policy data and data relating to the at least one point of variance; and
based upon said data, deploying said business process.

13. A method according to claim 12, wherein the at least one template includes the business logic required to guide the user through the process of filling in different parameters for the dynamically configurable business process.

14. A method according to claim 12, wherein said entering data includes entering data relating to an agreement, wherein the agreement associates roles with appropriate profiles, specifies appropriate parameters and sets up appropriate business policies.

15. A method according to claim 14, wherein a schema for said agreement is defined by XML.

16. A method according to claim 14, wherein an agreement includes information relating to at least one of a partner profile, a business process configuration component, partner reference data, mappings and transformations and legal business terms, a tracking profile, services, parties and ports.

17. A method according to claim 14, wherein a business policy is defined in an agreement based on at least one of instance data and aggregate data.

18. A method according to claim 17, wherein severity levels are assigned to the business policy.

19. A modulated data signal carrying computer executable instructions for performing the method of claim 12.

20. A computer readable medium comprising computer executable instructions for performing the method of claim 12.

21. A method for dynamically configuring a business process in a runtime environment based upon a business process model having at least one point of variance inserted therein, comprising:
receiving data relating to execution of the business process; and
checking said data relative to at least one of instance based policy and aggregate based policy to determine whether said data satisfies the objective of the business process.

22. A method according to claim 21, wherein said checking includes calling at least one function of a set of web services that support the execution of policies based on a context and policy name.

23. A method according to claim 21, wherein said checking results in at least one of (A) no violation, (B) an exception wherein a business processes need to be abandoned and an exception process needs to be started with a partner and (C) an internal error wherein a business process is abandoned and an internal error process is then started.

24. A modulated data signal carrying computer executable instructions for performing the method of claim 21.

25. A computer readable medium comprising computer executable instructions for performing the method of claim 21.

26. A method for dynamically configuring a business process in a runtime environment based upon a business process model having at least one point of variance inserted therein, comprising:
deploying the business process; and
tailoring the business process by operating upon an agreement for different scenarios after deployment without recompiling or re-building the business process.

27. A method according to claim 26, wherein a business policy is defined in an agreement based on at least one instance.

28. A method according to claim 26, wherein a schema for said agreement is defined by XML.

29. A business process configuration system for enabling the dynamic configuration and reuse of business processes in different contexts without recompilation and without involvement of development resources, comprising:
an application tools layer for generating a data representation of a dynamically configurable business process according to a dynamically configurable business process model based upon at least one point of variance;
a business user self service layer for receiving input relating to configuration of policies and partner agreements via at least one template, wherein the business user self service layer receives the data representation of the dynamically configurable business process and executes the business process;
a web services layer including business process configuration web services for dynamically configuring the business process based upon business user input in the business user self service layer; and
a server platform utilized by said web services layer to carry out functionality requested by the web services layer.

30. A system according to claim 29, wherein the server platform includes a business process configuration component interacting with a rules engine, a configuration database and an orchestration engine.

31. A system according to claim 29, wherein said web services layer includes at least one of (A) a get agreement list application programming interface (API) for returning a specified agreement list, (B) a create agreement API for adding a new agreement, (C) a Delete Agreement API for deleting an agreement, (D) an update agreement API for updating information about an agreement, (E) an activate agreement API for activating an existing agreement and (F) a deactivate agreement API for deactivating an existing agreement.

32. A system according to claim 29, wherein said web services layer includes a web service for the creation and access to policies allowing a business user to at least one of: (A) creation a policy value, (B)discovery of point of variance (C)Modification of policy value in a context (D)Run-time access to the policy value,

33. A system according to claim 29, wherein said web services layer includes an agreement web service for creating and deploying agreements operating to at least one of (A) create a new agreement, (B) deployment an agreement, (C) query an existing agreement, (D) modify an agreement, (E) version agreements, (F) approve of agreements, (G) provide role based access control to business process and (H) undeploy and delete agreements.

34. A system according to claim 29, wherein said business user self services layer includes a an agreement wizard for creating and modifying relationships relating to a business process agreement.

35. A system according to claim 34, wherein said agreement wizard enables creation or modification of at least one of: (A) a business process point of variance discovery, (C) an agreement template, (D) an agreement name, (E) a business process name, (F) a business process roles, (G) a business policy, (H) a business/legal term and (I) a UT experience for an agreement.

36. A computing system for providing dynamic business process configuration, comprising:
means for modeling a business process with a dynamically configurable business process model including means for inserting at least one point of variance into the business process model; and
means for generating at least one file for implementing said business process based on said business process model,
wherein said at least one point of variance specifies a point in the business process that is configurable.

37. A system according to claim 36, further comprising:
means for generating at least one template for the entry of data relating to said business process.

38. A computing system for deploying at least one file for implementing a dynamically configurable business process based on a business process model having at least one point of variance inserted therein, comprising:
means for entering data into at least one template for the entry of data relating to said business process including at least one of partner data, policy data and data relating to the at least one point of variance; and
means for deploying said business process based upon said data.

39. A system according to claim 38, wherein the at least one template includes the business logic required to guide the user through the process of filling in different parameters for the dynamically configurable business process.

40. A system according to claim 38, wherein said means for entering data includes means for entering data relating to an agreement, wherein the agreement associates roles with appropriate profiles, specifies appropriate parameters and sets up appropriate business policies.

41. A computing system for dynamically configuring a business process in a runtime environment based upon a business process model having at least one point of variance inserted therein, comprising:
means for receiving data relating to execution of the business process; and
means for checking said data relative to at least one of instance based policy and aggregate based policy to determine whether said data satisfies the objective of the business process.

42. A system according to claim 41, wherein said means for checking includes means for calling at least one function of a set of web services that support the execution of policies based on a context and policy name.

43. A computing system for dynamically configuring a business process in a runtime environment based upon a business process model having at least one point of variance inserted therein, comprising:
means for deploying the business process; and
means for tailoring the business process by operating upon an agreement for different scenarios after deployment without recompiling or re-building the business process.

44. A system according to claim 43, wherein a business policy is defined in an agreement based on at least instance data.
